(19) United States
(12) Patent Application Publication
(10) Pub. No.: US 2025/0224563 A1
(43) Pub. Date: Jul. 10, 2025

(54) SEMICONDUCTOR DEVICE AND SYSTEM FOR OPTICAL SIGNAL PROCESSING

(71) Applicant: Taiwan Semiconductor Manufacturing Company, Ltd., Hsinchu (TW)

(72) Inventors: Te-Hsien Hsieh, Kaohsiung City (TW); Shih-Wei Lin, Taipei City (TW); Hau-Yan Lu, Hsinchu City (TW); Wei-Kang Liu, Taichung City (TW)

(73) Assignee: Taiwan Semiconductor Manufacturing Company, Ltd., Hsinchu (TW)

(21) Appl. No.: 18/407,436

(22) Filed: Jan. 9, 2024

(51) Int. Cl. G02B 6/26; G02B 6/12; G02B 6/30; H04B 10/40

(52) U.S. Cl. CPC G02B 6/262; G02B 6/30; H04B 10/40; G02B 2006/12061

(57) ABSTRACT

A semiconductor device for optical signal transmitting includes a substrate and a silicon structure. The silicon structure is formed on a surface of the substrate, wherein the silicon structure comprises an upper surface, a lower surface, and side surfaces between the upper surface and the lower surface, the lower surface is in contact with the surface of the substrate. A plurality of first intermediate surfaces is between the lower surface and the side surfaces, and a plurality of second intermediate surfaces is between the upper surface and the side surfaces. The plurality of first intermediate surfaces is formed at different angles than the side surfaces, and the plurality of second intermediate surfaces is formed at different angles than the side surfaces.

### BACKGROUND

Silicon photonics (SiPh) technologies are emerging as important roles for high-speed optical data communication. For instance, optical transceiver modules including high-speed phase modulators, grating couplers and waveguides are used in high-speed optical communication systems. In addition, optical links benefit from distance insensitivity due to the inherently low loss of optical fibers, allowing for new types of connectivity and network organization in modern digital systems and data-centers. However, light loss is needed to be reduced in this field.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an X-Z plane schematic diagram of a system for optical signal processing in accordance with some embodiments of the present disclosure.

FIG. 2 illustrates a Y-Z plane schematic diagram of the system for optical signal processing of FIG. 1.

FIG. 3A illustrates a three-dimensional view of a semiconductor device in accordance with various embodiments of the present disclosure.

FIG. 3B illustrates a three-dimensional view of another semiconductor device in accordance with various embodiments of the present disclosure.

FIGS. 4A-4G illustrate cross-sectional views of a process for the formation of a semiconductor device in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, it will be understood that when an element is referred to as being “connected to” or “coupled to” another element, it may be directly connected to or coupled to the other element, or one or more intervening elements may be present. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “on,” “over,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Silicon photonics can potentially achieve lower energy and higher bandwidth density over electrical I/O. Compared with general optical interconnects, silicon photonic interconnects reduce manufacturing cost dramatically as the modulators and photodetectors are fabricated on standard silicon wafers instead of very expensive III-V wafers. In addition, silicon photonics are generally compatible with CMOS processes, enabling large-scale integration between CMOS circuits and photonic devices, such as monolithic integration and 3D integration. Silicon photonic interconnects achieve high bandwidth density and high energy efficiency through close electronic-photonic integration.

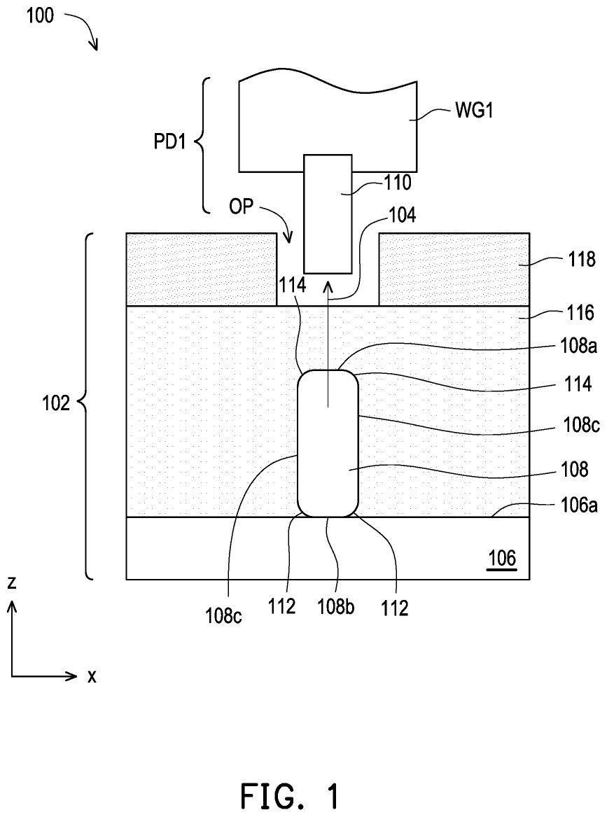

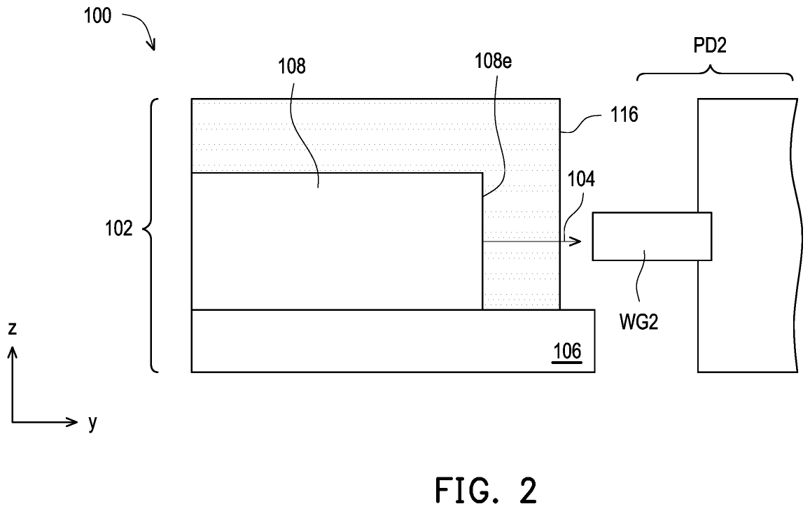

FIG. 1 illustrates an X-Z plane schematic diagram of a system for optical signal processing in accordance with some embodiments of the present disclosure. FIG. 2 illustrates a Y-Z plane schematic diagram of the system for optical signal processing of FIG. 1.

Referring to FIG. 1 and FIG. 2, a system 100 for optical signal processing includes a semiconductor device 102 configured to transmit one or more optical signals using a light beam 104, and photonic dies PD1 and PD2 configured to receive the light beam 104 for processing the one or more optical signals. The semiconductor device 102 includes a substrate 106 and a silicon tip 108 as a core of a single mode optical fiber. The silicon tip 108 is formed on a surface 106a of the substrate 106, wherein the silicon tip 108 comprises an upper portion 108a, a lower portion 108b, and sidewalls 108c extending from the upper portion 108a to the lower portion 108b. The substrate 106 is an oxide layer or a silicon-on-insulator (SOI) substrate. The silicon tip 108 may be single crystal silicon, polysilicon, or amorphous silicon.

In FIG. 1, a plurality of first edges 112 between the lower portion 108b and the sidewalls 108c is, in the cross-section view, a rounded edge formed at different angles than the sidewalls 108c; and a plurality of second edges 114 between the upper portion 108a and the sidewalls 108c is, in the cross-section view, a rounded edge. In some embodiments, the first edges 112 between the lower portion 108b and the sidewalls 108c is, in the cross-section view, a sloping edge formed at different angles than the sidewalls 108c; the second edges 114 between the upper portion 108a and the sidewalls 108c is, in the cross-section view, a sloping edge. In other words, the silicon tip 108 has a diamond shape in the cross-section view.

Referring to FIG. 1 again, the photonic die PD1 includes a first waveguide WG1 and a grating coupler 110 for coupling the light beam 104 from the silicon tip 108 into the first waveguide WG1, wherein the grating coupler 110 includes a plurality of grating lines that receive the light beam 104 and couple the light beam 104 into a core of the first waveguide WG1. The grating lines may be parallel to each other and may be straight or curved, e.g. may have shapes of concentric arc sections. In some embodiments, the first waveguide WG1 may be a slab waveguide, a rib waveguide, a channel waveguide, or a slot waveguide. In some embodiments, the first waveguide WG1 may have a plurality of ports for the light beam 104 with different wavelength ranges. The grating coupler 110 and the first waveguide WG1 are located on a substrate, and in some embodiments, the substrate may be formed with a semiconducting device or a dielectric material.

In some embodiments, an oxide layer 116 is formed on the surface 106a of the substrate 106 and cover the silicon tip 108, wherein the oxide layer 116 has a lower refractive index than that of the silicon tip 108. A dielectric layer 118 may be formed on the oxide layer 116, and an opening OP is formed in the dielectric layer 118. In some embodiments, the dielectric layer 118 includes a low k dielectric material, or the like. The opening OP vertically overlaps the silicon tip 108 as a light path, and thus the light beam 104 can be introduced to the grating coupler 110 through the opening OP. In some embodiments, the opening OP has a rectangular cross-sectional profile with two parallel sidewalls perpendicular to the surface 106a of the substrate 106. In some other embodiments, the opening OP has a tapered profile, in which a width at a top of the opening OP is wider than a width at a bottom of the opening OP. In addition, the width at the bottom of the opening OP may be wider than a width of the silicon tip 108, wherein the width of the silicon tip 108 is defined by a distance between two side surfaces 108c in the X-Z plane of FIG. 1.

In some embodiments, a distance and angle of incidence of silicon tip 108 relative to grating coupler 110 may be selected to enhance coupling efficiency and minimize losses. The silicon tip 108 may supply light signals to the grating coupler 110 or receive light signals from the grating coupler 110. For example, the grating coupler 110 may couple light signals from the first waveguide WG1 to the silicon tip 108. Additionally or alternatively, the grating coupler 110 may receive light signals coming from the silicon tip 108 and couple the light signals to the first waveguide WG1 or other (photonic) structures.

Referring to FIG. 2 again, the photonic die PD2 includes a second waveguide WG2 configured for edge coupling, and the tip end 108e of the silicon tip 108 is configured to align with the second waveguide WG2 of the photonic die PD2 such that the core of the silicon tip 108 is approximately aligned with a core of the second waveguide WG2 to form an optical interface for optical coupling of light therebetween. In some embodiments, the second waveguide WG2 may be a slab waveguide, a rib waveguide, a channel waveguide, or a slot waveguide. In some embodiments, the second waveguide WG2 may have a plurality of ports for different wavelength ranges.

In some embodiments, the tip end 108e of the silicon tip 108 in FIG. 2 connects with the second waveguide WG2 of the photonic die PD2, and another end of the silicon tip 108 connects with an optical source (not shown). When an optical signal is generated from the optical source, the optical signal is transmitted to the photonic die PD2 through the silicon tip 108. The second waveguide WG2 receives the optical signal from the silicon tip 108 and transmits the optical signal to the photonic die PD2.

In some embodiments, the photonic die PD1 and/or the photonic die PD2 include circuitry or other structures (not shown) that can generate optical signals, detect optical signals, analyze optical signals, modify optical signals, transfer optical signals, and/or transform optical signals to electrical signals; thereby enabling communication and/or signal processing between the photonic die PD1 and the semiconductor device 102 and/or between the photonic die PD2 and the semiconductor device 102. For example, the photonic die PD1 and/or the photonic die PD2 may further include optoelectronic component, such as a laser driver, digital control circuit, photodetectors, small form-factor pluggable (SFP) transceiver, High-speed phase modulator (HSPM), calibration circuit, distributed Mach-Zehnder Interferometer (MZI), light sources, (i.e., laser), or the like.

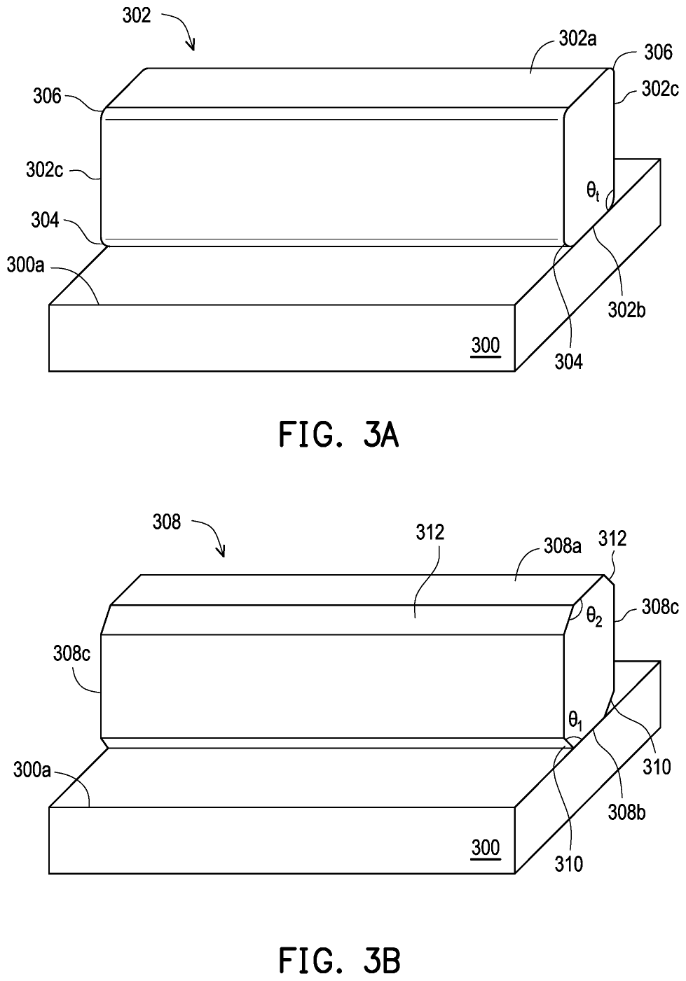

FIG. 3A illustrates a three-dimensional view of a semiconductor device in accordance with various embodiments of the present disclosure. FIG. 3B illustrates a three-dimensional view of another semiconductor device in accordance with various embodiments of the present disclosure.

Referring to FIG. 3A, a semiconductor device for optical signal transmitting includes a substrate 300 and a silicon structure 302. The substrate 300 is an oxide layer or a SOI substrate. The silicon structure 302 may be single crystal silicon, polysilicon, or amorphous silicon. The silicon structure 302 can be utilized in the system 100 of FIG. 1; for example, the silicon structure 302 is used as a silicon tip. The silicon structure 302 is formed on a surface 300a of the substrate 300, and the silicon structure 302 comprises an upper surface 302a, a lower surface 302b, and side surfaces 302c between the upper surface 302a and the lower surface 302b. The lower surface 302b is in contact with the surface 300a of the substrate 300. A plurality of first intermediate surfaces 304 is between the lower surface 302b and the side surfaces 302c, and a plurality of second intermediate surfaces 306 is between the upper surface 302a and the side surfaces 302c. The first intermediate surfaces 304 are formed at different angles than the side surfaces 302c, and the second intermediate surfaces 306 are formed at different angles than the side surfaces 302c. In this figure, the first intermediate surfaces 304 are convex surfaces, and the second intermediate surfaces 306 are convex surfaces. In some embodiments, a tip angle θt between one of the sidewalls 302c and the surface 300a of the substrate 300 is, for instance, 90°±2° such as 89°, 89.1°, 89.2°, 89.3°, 89.4°, 89.5°, 89.6°, 89.7°, 89.8°, 89.9°, 90°, 90.1°, 90.2°, 90.3°, 90.4°, 90.5°, 90.6°, 90.7°, 90.8°, 90.9°, or 91°. Since major optical loss in the optical system is caused by light filed shift, which is extremely sensitive to the tip angle θt, the light filed shift may be reduced by the first intermediate surfaces 304 and the second intermediate surfaces 304 for light confining improvement.

In some embodiments, each of the first intermediate surfaces 304 has a small radius of curvature compared to that of a flat surface (e.g. the side surfaces 302c). The small radius of curvature, in turn, reduce the light filed shift in the silicon structure 302. In some embodiments, and the second intermediate surfaces 306 has a small radius of curvature compared to that of a flat surface (e.g. the side surfaces 302c). The small radius of curvature, in turn, reduce the light filed shift in the silicon structure 302. In one embodiment, the radius of curvature of the first intermediate surfaces 304 is equal to or near the radius of curvature of the second intermediate surfaces 306. In another embodiment, the radius of curvature of the first intermediate surfaces 304 is different from the radius of curvature of the second intermediate surfaces 306.

Referring to FIG. 3B, the silicon structure 308 can also be utilized in the system 100 of FIG. 1; for example, the silicon structure 308 is used as a silicon tip. The silicon structure 308 is formed on a surface 300a of the substrate 300, and the silicon structure 308 comprises an upper surface 308a, a lower surface 308b, and side surfaces 308c between the upper surface 308a and the lower surface 308b. The lower surface 308b is in contact with the surface 300a of the substrate 300. A plurality of first intermediate surfaces 310 is between the lower surface 308b and the side surfaces 308c, and a plurality of second intermediate surfaces 312 is between the upper surface 308a and the side surfaces 308c. The first intermediate surfaces 310 are formed at different angles than the side surfaces 308c, and the second intermediate surfaces 312 are formed at different angles than the side surfaces 308c. In this figure, the first intermediate surfaces 310 are flat surfaces, and the second intermediate surfaces 312 are flat surfaces. In other words, the edges between the lower surface 308b and the side surfaces 308c are sloping edges, and the edges between the upper surface 308a and the side surfaces 308c are also sloping edges.

By simulation experiments, compared with the silicon structure without the first and second intermediate surfaces 310 and 312 (also called as comparative simulation example), when the tip angle θt is 89°, the light field shift of comparative simulation example is about 0.65 μm, and the light field shift of the silicon structure 308 with the first and second intermediate surfaces 310 and 312 (also called as simulation example) is about 0.25 μm; when the tip angle θt is 91°, the light field shift of comparative simulation example is about 0.75 μm, and the light field shift of the simulation example is about 0.15 μm. Accordingly, the silicon structure 308 with the first and second intermediate surfaces 310 and 312 can reduce the light filed shift by more than 70%, for example, more than 75%, or more than 80%.

In some embodiments, a first angle θ1 between one of the first intermediate surfaces 310 and the lower surface 308b is an obtuse angle, and a second angle θ2 between one of the second intermediate surfaces 312 and the upper surface 308a is also an obtuse angle. In one embodiment, the first angle θ1 is equal to or near the second angle θ2. In another embodiment, the first angle θ1 is different from the second angle θ2.

In some embodiments, the first intermediate surfaces 304 and 310 may be flat surfaces, convex surfaces, concave surfaces, or a combination thereof. In some embodiments, the second intermediate surfaces 306 and 312 may be flat surfaces, convex surfaces, concave surfaces, or a combination thereof. For example, each of the first intermediate surfaces 304 is a combination of flat surface and convex surface, and each of the second intermediate surfaces 306 is a combination of flat surface and convex surface. Alternatively, each of the first intermediate surfaces 304 is a combination of concave surface and convex surface, and each of the second intermediate surfaces 306 is a combination of concave surface and convex surface. For example, each of the first intermediate surfaces 310 is a combination of flat surface and convex surface, and each of the second intermediate surfaces 312 is a combination of flat surface and convex surface. Alternatively, each of the first intermediate surfaces 310 is a combination of concave surface and convex surface, and each of the second intermediate surfaces 312 is a combination of concave surface and convex surface. However, the disclosure is not limited thereto.

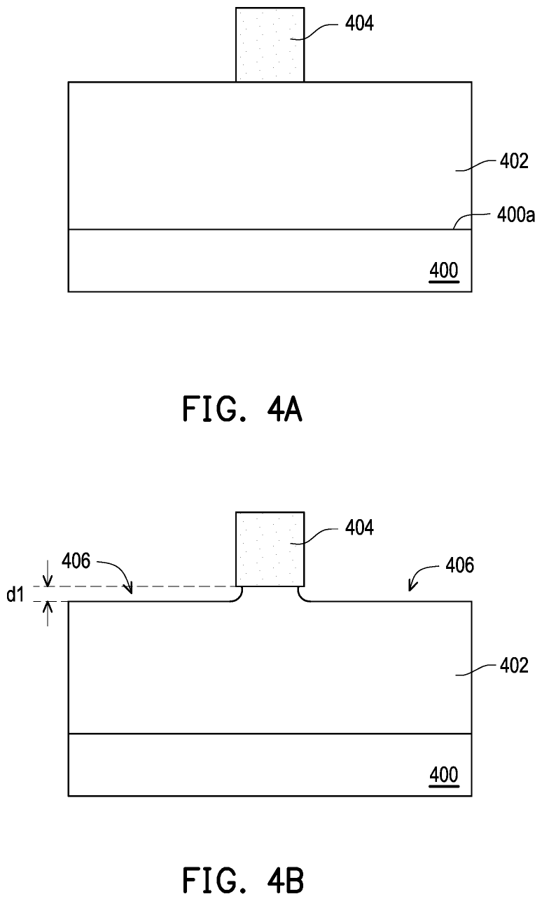

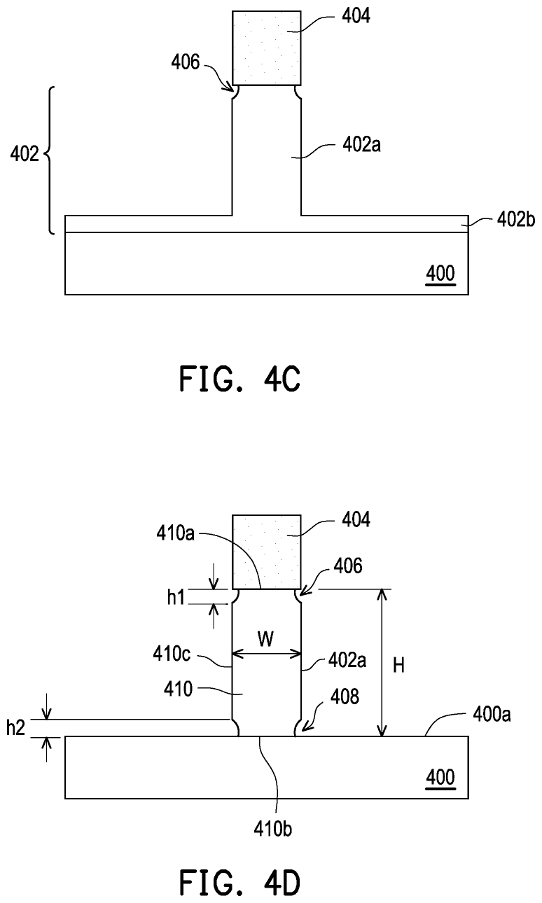

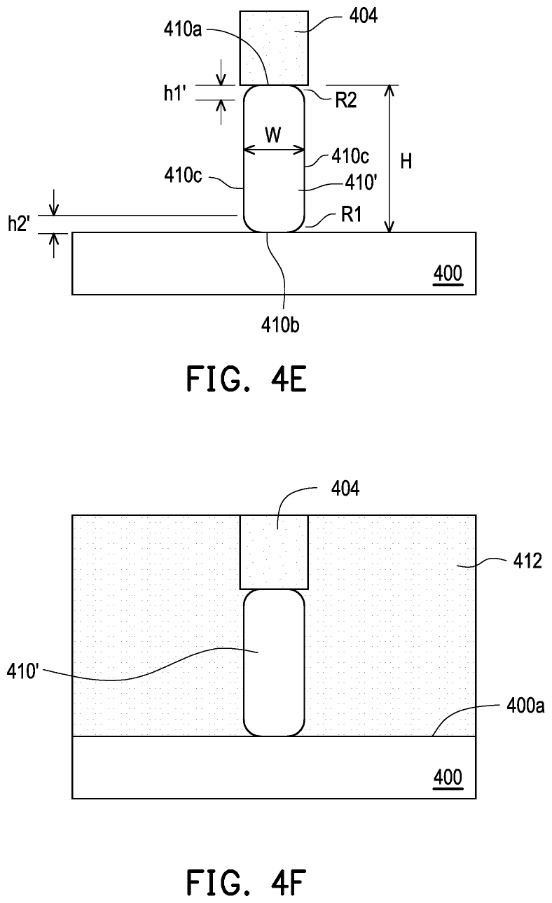

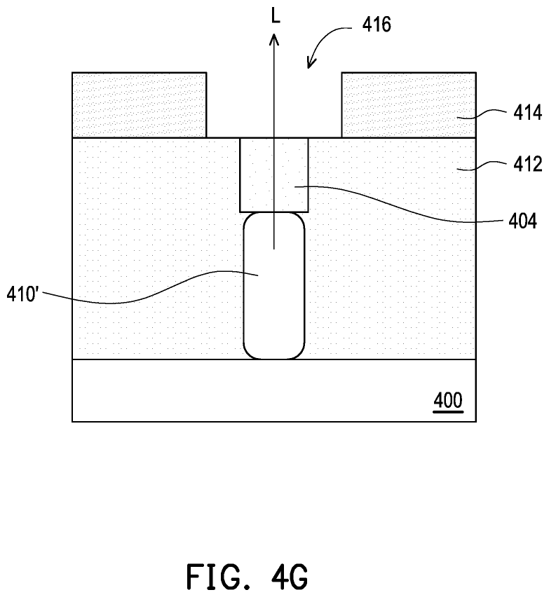

FIGS. 4A-4G illustrate cross-sectional views of a process for the formation of a semiconductor device in accordance with some embodiments of the present disclosure. The cross-section view is an X-Z plane similar to FIG. 1.

Referring to FIG. 4A, a silicon film 402 is formed on a surface 400a of a substrate 400, wherein the silicon film 402 may be single crystal silicon, polysilicon, or amorphous silicon. A mask 404 is then form on the silicon film 402. The silicon film 402 may be a single crystal silicon film, a polysilicon film, or an amorphous silicon film. If the silicon film 402 is a single crystal silicon film, the method of forming the single crystal silicon may include epitaxial growth, vapor-phase epitaxy (VPE), molecular beam epitaxy (MBE), or a suitable method. If the silicon film 402 is a polysilicon film, the method of forming the polysilicon film may include CVD process followed by a thermal treatment, or other suitable processes. If the silicon film 402 is an amorphous silicon film, the method of forming the amorphous silicon film may include CVD process or other suitable processes. In some embodiments, the mask 404 may be a photoresist mask, an oxide mask, or a silicon nitride mask. In one embodiment, the mask 404 is a photoresist mask, and the method of forming the mask 404 may include coating a photoresist (not shown) on the surface 400a of a substrate 400, and then performing an exposure developing process on the photoresist. In another embodiment, the mask 404 is an oxide mask or a silicon nitride mask, and the method of forming the mask 404 may include forming an oxide layer (not shown) or a silicon nitride layer (not shown) on the surface 400a of a substrate 400, performing a photolithography process on the oxide layer or the silicon nitride layer, and etching a portion of the oxide layer or the silicon nitride layer so as to keep the mask 404 on the surface 400a.

Referring to FIG. 4B, an isotropic etching is performed on the silicon film 402 by using the mask 404 as an etching mask. In some embodiments, the etchant for the isotropic etching may include F base etchant such as tetrafluoromethane (CF₄) or sulfur hexafluoride (SF₆), etc. In some embodiments, the etching duration for the isotropic etching may be determined by etching rate (ER) and target etch amount; for example, the etching duration may be 10 see to 1 min. After the isotropic etching, a recess 406 is formed on the top of the silicon film 402. A depth d1 of the recess 406 is determined by the etching duration or other etching parameters of the isotropic etching, and the depth d1 of the recess 406 would be the placement of a top of a to-be-formed tip portion.

Referring to FIG. 4C, an anisotropic etching is performed on the silicon film 402 by using the mask 404 as an etching mask. In some embodiments, the anisotropic etching may be dry etching with F base gas or Cl base gas, such as SF₆, HBr, Cl₂, O₂, Ar, etc. After the anisotropic etching, a bottom 402b of the silicon film 402 is remained, and a tip portion 402a is formed below the mask 404. In this stage, the recess 406 at the top of the silicon film 402 is located on the tip portion 402a. The remainder portion (i.e. the bottom 402b) of the silicon film 402 would be the location of a bottom of the to-be-formed tip portion.

Referring to FIG. 4D, a high selective etching is performed on the bottom 402b of the silicon film 402 by using the mask 404 as an etching mask. In some embodiments, the high selective etching represents an etching process with high etching selectivity to Si/OX, and it may use F, Cl, Br base gas with a passivation gas addition (e.g. octafluorocyclobutane (C₄F₈)). After the high selective etching, another recess 408 is formed at the bottom of the tip portion 402a. Therefore, a silicon tip 410 is formed on the surface 400a of the substrate 400. During the high selectivity etching, the recess 406 located on the tip portion 402a. may be protected by the polymer gas, and thus the recess 406 is slightly removed and keep the concave profile.

The silicon tip 410 comprises an upper surface 410a, a lower surface 410b, and side surfaces 410c between the upper surface 410a and the lower surface 410b, the lower surface 410b is in contact with the surface 400a of the substrate 400. The surface in the recess 408 is a concave surface, and, and the surface in the recess 406 is also a concave surface. In some embodiments, a height H of the silicon tip 410 is between 2 μm and 4 μm, and a width w of the silicon tip 410 is between 0.5 μm and 1 μm. However, the disclosure is not limited thereto. In the disclosure, the height H of the silicon tip 410 is defined by a distance between the upper surface 410a and the lower surface 410b in the cross-sectional view; the width w of the silicon tip 410 is defined by a distance between two side surfaces 410c in the cross-sectional view. In some embodiments, a ratio of the height H to the width w may be 2 to 8; for instance, 2, 3, 4, 5, 6, 7, or 8. In some embodiments, a height h1 at the recess 406 is between 0.4 μm and 1 μm, and a height h2 at the recess 408 is between 0.4 μm and 1 μm. However, the disclosure is not limited thereto. In the disclosure, the height h1 is defined by a vertical distance between the upper surface 410a and a bottom of the recess 406 in the cross-sectional view; the height h2 is defined by a vertical distance between the lower surface 410b and a top of the recess 408 in the cross-sectional view. In some embodiments, a ratio of the height h1 to the height H may be 0.1 to 0.5; for instance, 0.1, 0.2, 0.3, 0.4, or 0.5. In some embodiments, a ratio of the height h2 to the height H may be 0.1 to 0.5; for instance, 0.1, 0.2, 0.3, 0.4, or 0.5.

In some embodiments, the recess 406 at the top of the silicon film 402 in FIG. 4B is located on the tip portion 402a, and thus it is possible to determine the height h1 at the recess 406 by the isotropic etching in FIG. 4B. On the other hand, the remainder portion (i.e. the bottom 402b) of the silicon film 402 in FIG. 4C would be the location of a bottom of the tip portion 402a. That is, the height h2 of the recess 408 may be determined by the anisotropic etching in FIG. 4C.

Referring to FIG. 4E, a reflow process may be performed on the silicon tip 410 such that the top and bottom of the silicon tip 410 are rounded. In some embodiments, the reflow process has following parameters: the reflow temperature is between 800° C. and 1,000° C., the reflow duration is tens of minutes to 1 hour, and the reflow pressure is between 1 μm Torr and 100 m Torr. Accordingly, a silicon tip 410′ with rounded edges R1 and R2 is formed on the surface 400a of the substrate 400. The rounded edge R1 is between the lower surface 410b and the side surfaces 410c, and the rounded edge R2 is between the upper surface 410a and the side surfaces 410c. In some embodiments, the height H of the silicon tip 410′ is between 2 μm and 4 μm, and the width w of the silicon tip 410′ is between 0.5 μm and 1 μm. However, the disclosure is not limited thereto. In some embodiments, a ratio of the height H to the width w may be 2 to 8. In some embodiments, a height h1′ at the rounded edges R2 is between 0.4 μm and 1 μm, wherein the height h1′ is defined by a vertical distance between the upper surface 410a and a bottom of the rounded edges R2 in the cross-sectional view; and a height h2′ at the rounded edges R2 is between 0.4 μm and 1 μm, wherein the height h2′ is defined by a vertical distance between the lower surface 410b and a top of the rounded edge R1 in the cross-sectional view. However, the disclosure is not limited thereto. In some embodiments, a ratio of the height h1′ to the height H may be 0.1 to 0.5, and a ratio of the height h2′ to the height H may be 0.1 to 0.5. Since the silicon tip 410 of FIG. 4D undergoes the reflow process, the height h1′ may be larger than the height h1, and/or the height h2′ may be larger than the height h2. Moreover, a curvature of the rounded edges R1 and a curvature of the rounded edges R2 may be varied by the reflow process. For example, the curvature of the rounded edges R1 and the curvature of the rounded edges R2 may be decreased along with an increase of the reflow duration, or the curvature of the rounded edges R1 and the curvature of the rounded edges R2 may be decreased along with an raising of the reflow temperature. On the contrary, the curvature of the rounded edges R1 and the curvature of the rounded edges R2 may be increased along with a decrease of the reflow duration, or the curvature of the rounded edges R1 and the curvature of the rounded edges R2 may be increased along with a drop of the reflow temperature. In addition, the reflow pressure may be adjusted for the desired curvature of the rounded edges R1 and the desired curvature of the rounded edges R2.

The step of FIG. 4F may be omitted. Alternatively, the step of FIG. 4F may be accomplished because the rounded edges R1 between the side surfaces 410c and the upper surface 410a and the rounded edges R2 between the side surfaces 410c and the lower surface 410b are more beneficial in reducing light field shift.

Referring to FIG. 4F, an oxide layer 412 is formed on the surface 400a of the substrate 400 to cover the silicon tip 410′ and the mask 404, and then a planarization process is performed on the oxide layer 412 until the mask 404 is exposed. In some embodiments, the method of forming the oxide layer 412 may include chemical vapor deposition (CVD), atomic layer deposition (ALD), or a suitable method. In some embodiments, the planarization process includes CMP (Chemical-Mechanical Planarization), etching, polishing, combinations thereof, or the like to provide a structure as shown in FIG. 4F.

Referring to FIG. 4G, a dielectric layer 414 is formed on the oxide layer 412, and then an opening 416 is formed in the dielectric layer 414 over the silicon tip 410′ and the mask 404. In some embodiments, the method of forming the dielectric layer 414 may include chemical vapor deposition (CVD), atomic layer deposition (ALD), or a suitable method; the dielectric layer 414 may include a low k dielectric material, or the like. In some embodiments, the method of forming the opening 416 may include coating a photoresist (not shown) on the dielectric layer 414, performing an exposure developing process on the photoresist to expose a portion of the dielectric layer 414, and etching the exposed portion of the dielectric layer 414 by using the photoresist as an etching mask. The opening 416 vertically overlaps the silicon tip 410′ as a light path, and thus a light beam L can be introduced to a grating coupler (not shown) through the opening 416. Regarding to the semiconductor device along a longitudinal direction (into the page), please refer to FIG. 2, the silicon tip 410′ has a tip end similar to the silicon tip 108, and the tip end is configured to edge coupling.

According to some embodiments, the semiconductor device for optical signal transmitting includes a substrate and a silicon structure. The silicon structure is formed on a surface of the substrate, wherein the silicon structure comprises an upper surface, a lower surface, and side surfaces between the upper surface and the lower surface, the lower surface is in contact with the surface of the substrate. A plurality of first intermediate surfaces between the lower surface and the side surfaces, and a plurality of second intermediate surfaces between the upper surface and the side surfaces. The plurality of first intermediate surfaces is formed at different angles than the side surfaces, and the plurality of second intermediate surfaces is formed at different angles than the side surfaces.

According to some embodiments, the semiconductor device for optical signal transmitting includes a substrate and silicon tip. The silicon tip is formed on a surface of the substrate, wherein the silicon tip includes an upper portion, a lower portion, and sidewalls extending from the upper portion to the lower portion, wherein a plurality of first edges between the lower portion and the sidewalls is, in a cross-section view, a rounded edge or a sloping edge formed at different angles than the sidewalls, and a plurality of second edges between the upper portion and the sidewalls is, in the cross-section view, a rounded edge or a sloping edge formed at different angles than the sidewalls.

According to some embodiments, the system for optical signal processing includes a semiconductor device configured to transmit one or more optical signals using a light beam, and a photonic die configured to receive the light beam for processing the one or more optical signals. The semiconductor device includes a substrate and silicon tip. The silicon tip is formed on a surface of the substrate. The silicon tip comprises an upper portion, a lower portion, and sidewalls extending from the upper portion to the lower portion. A plurality of first edges between the lower portion and the sidewalls is, in a cross-section view, a rounded edge or a sloping edge formed at different angles than the sidewalls, and a plurality of second edges between the upper portion and the sidewalls is, in the cross-section view, a rounded edge or a sloping edge formed at different angles than the sidewalls.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device for optical signal transmitting, comprising:
a substrate having a surface; and
a silicon structure, formed on the surface of the substrate, wherein the silicon structure comprises an upper surface, a lower surface, and side surfaces between the upper surface and the lower surface, the lower surface is in contact with the surface of the substrate, and
a plurality of first intermediate surfaces between the lower surface and the side surfaces,
a plurality of second intermediate surfaces between the upper surface and the side surfaces,
the plurality of first intermediate surfaces is formed at different angles than the side surfaces, and
the plurality of second intermediate surfaces is formed at different angles than the side surfaces.

2. The semiconductor device for optical signal transmitting of claim 1, wherein the plurality of first intermediate surfaces are flat surfaces, convex surfaces, concave surfaces, or a combination thereof.

3. The semiconductor device for optical signal transmitting of claim 1, wherein the plurality of second intermediate surfaces are flat surfaces, convex surfaces, concave surfaces, or a combination thereof.

4. The semiconductor device for optical signal transmitting of claim 1, further comprising an oxide layer covering the silicon structure.

5. The semiconductor device for optical signal transmitting of claim 1, wherein the substrate is an oxide layer or a SOI substrate.

6. The semiconductor device for optical signal transmitting of claim 1, wherein the silicon structure is single crystal silicon, polysilicon, or amorphous silicon.

7. A semiconductor device for optical signal transmitting, comprising:
a substrate having a surface; and
a silicon tip, formed on the surface of the substrate, wherein the silicon tip comprises an upper portion, a lower portion, and sidewalls extending from the upper portion to the lower portion, wherein
a plurality of first edges between the lower portion and the sidewalls is, in a cross-section view, a rounded edge or a sloping edge formed at different angles than the sidewalls, and
a plurality of second edges between the upper portion and the sidewalls is, in the cross-section view, a rounded edge or a sloping edge formed at different angles than the sidewalls.

8. The semiconductor device for optical signal transmitting of claim 7, wherein the plurality of first edges is the rounded edge, and the plurality of second edges is the rounded edge.

9. The semiconductor device for optical signal transmitting of claim 7, wherein the plurality of first edges is the sloping edge, and the plurality of second edges is the sloping edge.

10. The semiconductor device for optical signal transmitting of claim 7, further comprising an oxide layer covering the silicon tip.

11. The semiconductor device for optical signal transmitting of claim 7, wherein the substrate is an oxide layer or a SOI substrate.

12. The semiconductor device for optical signal transmitting of claim 7, wherein the silicon tip is single crystal silicon, polysilicon, or amorphous silicon.

13. A system for optical signal processing, comprising:
a semiconductor device configured to transmit one or more optical signals using a light beam; and
a photonic die configured to receive the light beam for processing the one or more optical signals, wherein
the semiconductor device comprising:
a substrate having a surface; and
a silicon tip, formed on the surface of the substrate, wherein the silicon tip comprises an upper portion, a lower portion, and sidewalls extending from the upper portion to the lower portion, wherein
a plurality of first edges between the lower portion and the sidewalls is, in a cross-section view, a rounded edge or a sloping edge formed at different angles than the sidewalls, and
a plurality of second edges between the upper portion and the sidewalls is, in the cross-section view, a rounded edge or a sloping edge formed at different angles than the sidewalls.

14. The system for optical signal processing of claim 13, wherein the photonic die comprises a first waveguide and a grating coupler for coupling the light beam from the silicon tip of the semiconductor device.

15. The system for optical signal processing of claim 14, wherein the grating coupler is disposed over the upper portion of the silicon tip.

16. The system for optical signal processing of claim 13, wherein the photonic die comprises a second waveguide configured for edge coupling.

17. The system for optical signal processing of claim 16, wherein the silicon tip has a tip end is at an end surface of the silicon tip, and the end surface is a surface except for the sidewalls.

18. The system for optical signal processing of claim 17, wherein the tip end is configured to align with the second waveguide of the photonic die.

19. The system for optical signal processing of claim 13, wherein the plurality of first edges is the rounded edge, and the plurality of second edges is the rounded edge.

20. The system for optical signal processing of claim 13, wherein the plurality of first edges is the sloping edge, and the plurality of second edges is the sloping edge.
